(19) United States
(12) Patent Application Publication
(10) Pub. No.: US 2017/0144245 A1
(43) Pub. Date: May 25, 2017

(54) WELDING CAP COOLING WATER CONTROL SYSTEM

(71) Applicant: Buerkert Werke GmbH, Ingelfingen (DE)

(72) Inventors: Hartmuth LOTHA, Kupferzell (DE); Juergen STRAUB, Oedheim (DE)

(21) Appl. No.: 15/360,414

(22) Filed: Nov. 23, 2016

(30) Foreign Application Priority Data
Nov. 23, 2015 (DE) 10 2015 120 222.0

(51) Int. Cl. B23K 11/30; F28F 27/02

(52) U.S. Cl. CPC B23K 11/3018; F28F 27/02

(57) ABSTRACT

A welding cap cooling water control system has a cooling water conduit with a cooling water inflow leading in direction of the welding cap and a cooling water return flow leading away from the welding cap, in which a flow sensor and a control valve are seated. On the side of the inflow or the return flow the cooling water flow is controlled by a flow control valve which also serves for emergency shut-off in the case of pressure loss.

### FIELD OF THE INVENTION

This invention relates to a welding cap cooling water control system, comprising a cooling water conduit which has a cooling water inflow leading in direction of the at least one welding cap and a cooling water return flow leading away from the welding cap, wherein in the cooling water return flow a switchable control valve for closing the cooling water return flow during a cap change and at least one flow sensor are provided.

### BACKGROUND

Robotic spot welding systems in particular are in use in the automotive industry and must meet high demands on quality. A high availability required up to 100% demands a maximum reliability of all components. The welding caps are subject to high thermal loads and wear and are permanently cooled by cooling water. Upon removal of a welding cap a 2-2-way valve, which in the prior art is provided in the inflow, is switched to CLOSED, and at the same time also the control valve in the return flow. There is also opened a water receiving device, for example a passively widening expansion space, so that water from the conduit portion between the control valves is received in the inflow and in the return flow. Hence, due to the immediate pressure reduction in the cooling water conduit no coolant under high pressure can exit.

### SUMMARY

The present invention improves the cooling water control system without any additional financial expenditure worth mentioning.

The welding cap cooling water control system according to the invention comprises a cooling water conduit which includes a cooling water inflow leading in direction of at least one welding cap and a cooling water return flow leading away from the at least one welding cap, wherein in the cooling water return flow a switchable control valve for closing the cooling water return flow during a cap change and at least one flow sensor are provided, wherein in the cooling water inflow or cooling water return flow an electronically controlled flow control valve is seated.

The electronically controlled flow control valve replaces the control valve previously seated in the inflow and is able to reduce the water consumption, because actually only that cooling water quantity is pumped through which is necessary for optimum cooling. The circulation pump performance also can be reduced, with the service expenditure being reduced at the same time. In addition, the so-called water hammer necessary and occurring so far in the cooling water circuit is avoided. These impacts occurring due to the abrupt switching operation of a control valve in the cooling water conduit also could cause a welding cap loss, which is avoided by the welding cap cooling water control system according to the invention. Due to the flow control valve, the exact cooling water quantities necessary are available to the welding cap or to the plurality of welding caps, which are cooled by a cooling conduit, from the beginning, although the conduit resistance and/or system pressure constantly are changed. This is the case in particular when the welding cap is seated on a robot which is coupled with flexible cooling hoses or for example further systems are switched on or off. These cooling hoses are bent, possibly upset, during the movements of the, robot, so that the cooling water conduit has different resistances during the operation. These resistances are compensated immediately by the flow control valve.

Due to the lower pump performance on average, less expensive pumps can be installed and in continuous operation the power consumption can be reduced. Due to the reproducible supply of cooling power, the welding quality also can be improved sustainably and permanently remain at a high level.

Preferably, there is provided a control unit which is coupled with the at least one flow sensor, the control valve and the flow control valve and controls the same or picks up data from the same. It thereby is possible that the flow sensor provided anyway is employed for the control of the flow control valve, so that here as well no additional expenditure is required.

As mentioned, the flow sensor in particular is seated in the return line and can detect the flow rate, the water temperature and/or the pressure. By means of the flow sensor changes in the pressure or throughflow then can also be detected immediately, which possibly also indicate a leakage in the cooling water conduit. The control system is programmed such that when the pressure or throughflow falls below a predetermined value, it infers such leakage and hence triggers an alarm. Previously provided additional devices which have detected and indicated such leakage now are superfluous, as such an alarm system technically is easy to realize in the cooling water control system according to the invention.

Furthermore, a switchable water receiving device should be present, which during a cap change is actuatable electrically and takes up cooling water from a conduit portion between the flow control valve and the control valve. As mentioned, this serves to be able to accomplish an immediate pressure reduction in the cooling water conduit.

The water receiving device comprises an expansion space which has a movable wall on which in particular an adjustable counterpressure to the water pressure in the conduit portion can be applied. In the simplest case the expansion space is part of a piston-cylinder unit, wherein the expansion space is located on one side of the piston and the counterpressure is built up in the space on the other side of the piston. For example, this can be effected in that a hydraulic or pneumatic line opens into this space, wherein here an adjustable throttle valve and/or a supplementary valve preferably can also be provided. The counterpressure thereby can be adjusted easily.

As an alternative thereto, an active water receiving device also might be coupled, which comprises a motor-driven piston or a piston movable by negative pressure or a hydraulically or pneumatically driven piston. This piston is actively moved when a leakage occurs, so that it sucks in cooling water from the cooling water conduit.

The control unit preferably is formed and programmed such that on the inflow side only the flow control valve is electrically switched during a cap change and/or a leakage in the cooling water conduit, in order to stop the inflow of cooling water. Additional control valves hence are superfluous. The flow control valve simply is switched to CLOSED.

The cooling water control system according to the invention is formed such that it also cools several welding caps, which are flown through one after the other. The coolant hence flows along or through several welding caps.

The flow control valve controls the cooling water quantity for all welding caps provided in the cooling water conduit, i.e. there is provided only one flow control valve according to a preferred aspect of the invention. This flow control valve should be arranged before the first welding cap.

When the flow control valve is arranged in the return flow, a shut-off valve should be positioned in the inflow, which during a welding cap change closes like the flow control valve.

There can be provided one or more flow sensors, for example in total only one flow sensor, which is arranged before the control valve seated after the last welding cap, or several flow sensors can be present between the flow control valve and the control valve. For example, a separate flow sensor also can be used for each welding cap, which normally however is not necessary.

The control unit is formed such that in the case of a pressure drop below a predetermined value, which is detected by the flow sensor, it actively actuates and closes the control valve. Thus, the flow sensor has several functions. It serves to determine the throughflow of the cooling water for the adaptation of the flow rate. In addition, it is part of the alarm system which reveals a leakage.

In the cooling water control system of the present invention the cooling water quantity also is automatically controlled to the optimum value when further consumers are added, consumers (welding robots) are deactivated or the cooling ater conduit has other resistances due to movements of the robot.

The flow control valve can be opened and closed steplessly, possibly also be closed completely.

### BRIEF DESCRIPTION OF THE DRAWINGS

FIG. 1 shows a circuit diagram of the welding cap cooling water control system according to the invention.

FIG. 2 shows a sectional view through the flow control valve which is used in the welding cap cooling water control system according to the invention, and

FIGS. 3 to 5 show successive stages during the movement of the flow control valve according to FIG. 2 from the open into the partly open and finally into the closed position.

### DETAILED DESCRIPTION

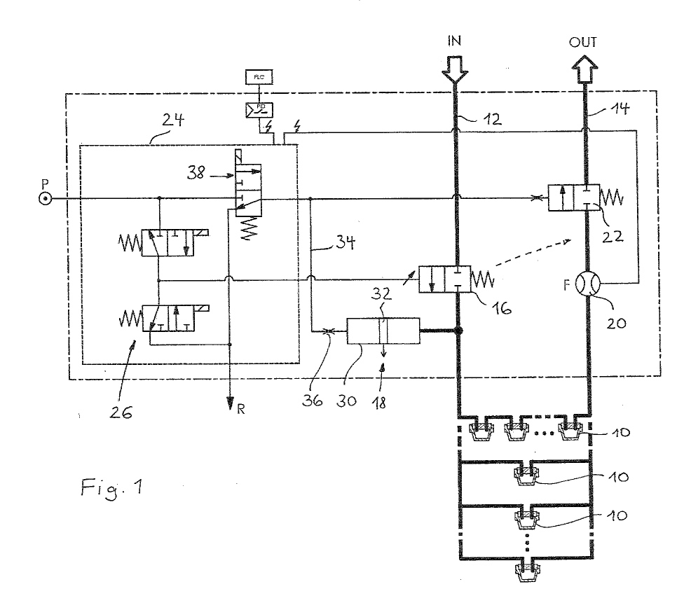

FIG. 1 shows a welding cap cooling water control system for one or more welding caps 10 which are seated on a welding robot or on a plurality of welding robots. By way of example, series and parallel arrangements of welding caps are shown. A cooling water conduit is configured as circuit and comprises a cooling water inflow 12 as well as a cooling water return flow 14, which lead to and away from the welding caps 10.

When several welding caps 10 are present, which are cooled with a welding cap cooling water control system, a series connection of the welding caps 10 in the cooling water conduit preferably is obtained in technical terms.

In the cooling water inflow 12 an electronically actuatable and controllable flow control valve 16 is seated, namely before the first welding cap 10. Between the first welding cap 10 and the flow control valve 16 a conduit (dead-end conduit) leading to a water receiving device 18 branches off from the cooling water inflow. Optionally, the flow control valve 16 can be seated in the return flow 14, as is symbolized with the arrow shown in broken lines. At the position of the flow control valve 16 in the inflow 12 a shut-off valve is arranged.

After the last welding cap 10 a flow sensor 20 is arranged in the cooling water return conduit 14, and after the flow sensor an electrically switchable control valve 22, here a 2-2-way valve. This control valve is spring-loaded, namely into a closed position. Of course, an open position also might be provided in the case of a power failure.

On the control side, a so-called PLC, also referred to as SPS, is coupled with a downstream PID controller. Preferably, the PLC is provided on the system side, i.e. provided by the system operator, whereas the PID is coupled with a control unit 24 of the cooling water control system or forms a part of the same.

The flow control valve 16, the water receiving device 18, the flow sensor 20 and the control valve 22 are electrically coupled with the control unit 24 and send data or receive control data from the control unit 24. The corresponding conduit routing is shown in FIG. 1.

The control unit 24 for example controls hydraulic or pneumatic valves 26, which in turn actuate the flow control valve 16.

In addition, the water receiving device 18 is controlled. In the illustrated exemplary embodiment the water receiving device 18 comprises a cylinder 30 in which a shiftable piston 32 is located as movable wall. The right-hand space separated by the piston 32 in the cylinder 30 is coupled with the cooling water inflow 12, and the opposite space is coupled with a conduit 34 in which a throttle 36 is seated. The conduit 34 leads to a pilot control valve 38 which either opens the conduit 34 to the environment or separates it from the same. The conduit 34 either is pressurized or vented.

Depending on the data provided by the flow sensor 20, the control unit 24 actuates the flow control valve 16, in order to proportionally open or close the same.

The flow control valve 16 can be opened and closed steplessly, possibly also be closed completely.

Depending on the resistance in the cooling water conduit, on the number of welding caps 10 to be cooled and also on the cooling water temperature (in particular in the return conduit), the optimum throughflow of cooling water is set in the flow control valve 16.

A non-illustrated pump, which however also is actuated via the control unit 24, can additionally be operated steplessly more or less strongly, in order to let cooling water flow through the cooling water conduit.

Possible temperature sensors are not shown either in this connection, which possibly are arranged in the flow sensor 20 or in its vicinity, so that not only the flow rate, but also the temperature of the cooling water is detected and taken into account in the control unit 24 for setting the flow control valve 16.

When a leakage is detected due to an abrupt decrease in throughflow, for example in the flow sensor 20, the control unit 24 immediately actuates the flow control valve 16, which is responsible, preferably solely responsible for inhibiting the flow of coolant to the welding caps 10. Correspondingly, the control valve 22 also is switched to CLOSED.

In the case of a pressure drop, the pilot control valve 38 furthermore is actuated, which couples the space on the left of the piston 32 with the environment, so that the overpressure in the conduit portion between the flow control valve 16 and the control valve 22 leads to the fact that the piston 32 is urged to the left. Pressure peaks thus are reduced immediately.

The pressure course present in the left space in the cylinder 30 is adjustable, namely via the throttle 36, possibly also via a control valve as pilot control valve 38.

When more welding caps 10 are connected, it is detected at this point via the flow sensor 20 or via the plurality of sensors that more cooling capacity must be provided, and the control unit 24 correspondingly actuates the control valve 16 and possibly the pump, in order to supply more cooling water.

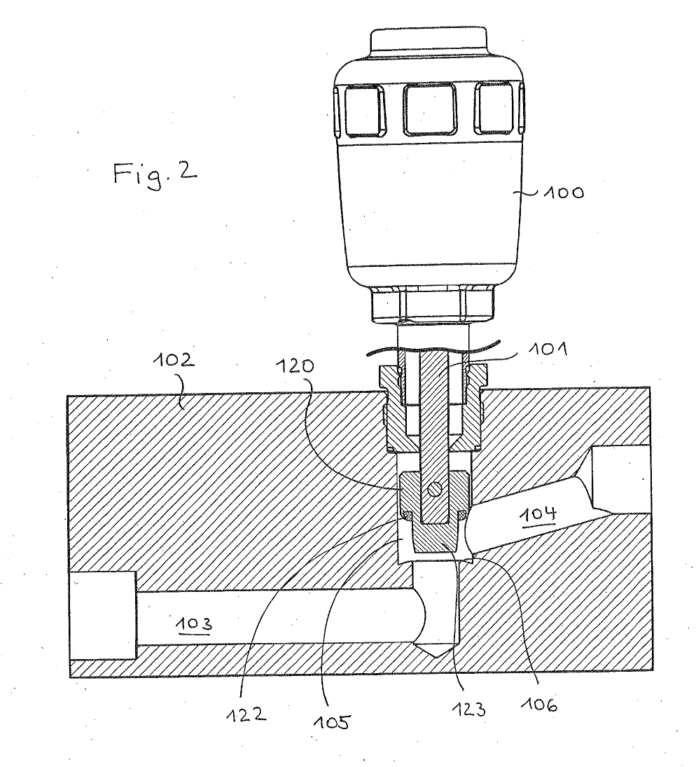

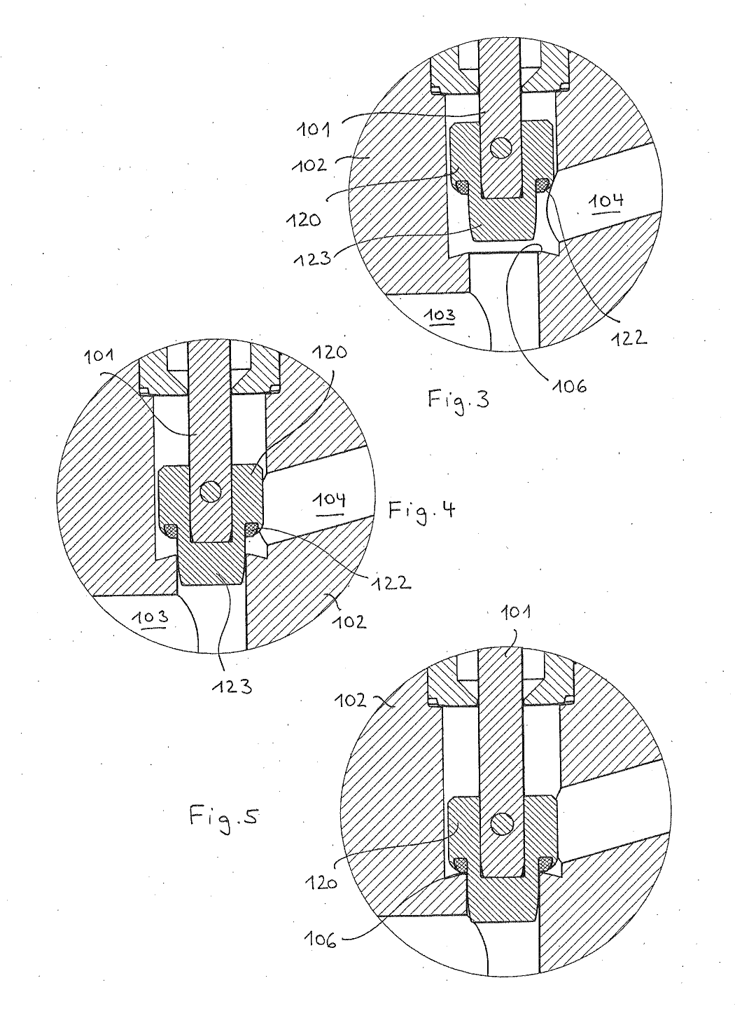

FIGS. 2-5 show the flow control valve 16 in various stages of movement.

The flow control valve 16 is an electronically controlled valve which includes a controllable electric drive 100 which is able to steplessly axially shift a linearly movable spindle 101.

The spindle 101 moves in a valve housing 102 symbolically represented here as block, which is traversed by flow passages 103, 104. On the spindle 101 a closing element 120 is mounted, which more or less clears or closes a flow connection between the flow passages 103 and 104 transitioning into each other. This is effected without steps, i.e. stepless.

The valve comprises a so-called control opening 105 in which the closing element 120 can move. On an edge, more exactly on a kind of shoulder of the control opening 105 a valve seat 106 is formed.

On the closing element 120 a sealing element 122 is mounted, here in the form of an O-ring. Furthermore, a so-called control cone 123 is formed, which conically tapers towards the tip of the closing element 120. The control cone 123 has a special shape which provides a characteristic flow path. The control cone 123 hence is designed and optimized for certain flow characteristics which result from the axial movement of the closing element 120 in the control opening 105.

In the illustrated exemplary embodiment the so-called control quality is optimized towards small flow rates. In FIG. 4 such small throughflow is possible. This is shown by the fact that the cleared flow cross-section is increased only slowly on opening of the valve. Only when the control cone 123 still dips into the control opening 105 for about 30-50% of its axial length is the free flow cross-section changed distinctly. When the valve is closed, the sealing element 122, as this is shown in FIG. 5, rests against the valve seat 106 and separates the flow passages 103 and 104 in a fluid-tight manner.

The drive 100 is an electromotive or pneumatic drive. The welding cap cooling water control system is able to continuously compensate the usual fluctuations in the cooling water system, so that there is always obtained an optimum welding result. With the illustrated flow control valve 16 the cooling system can optimally be adjusted continuously in line with the welding parameters (current intensity, sheet thickness, number of sheet layers, material, welding quality, etc.). In addition, by active control of the throughflow a diagnosis of the cooling water system can be carried out. It also is possible to diagnose the wear of the welding caps via the position of the closing element 120 or by the setpoint specification of the flow control valve.

1. A welding cap cooling water control system, comprising a cooling water conduit which includes a cooling water inflow leading in direction of at least one welding cap and a cooling water return flow leading away from the at least one welding cap, wherein in the cooling water return flow a switchable control valve for closing the cooling water return flow during a cap change and at least one flow sensor are provided, wherein in the cooling water inflow or cooling water return flow an electronically controlled flow control valve is seated.

2. The welding cap cooling water control system according to claim 1, wherein a control unit is provided, which is coupled with the flow sensor, the control valve and the flow control valve and controls the same or picks up data from the same.

3. The welding cap cooling water control system according to claim 2, wherein the control unit includes a PID controller.

4. The welding cap cooling water control system according claim 1, wherein a switchable water receiving device is present, which during a cap change is actuatable electrically and takes up cooling water from a conduit portion between the flow control valve and the control valve.

5. The welding cap cooling water control system according to claim 4, wherein the water receiving device includes an expansion space which has a movable wall.

6. The welding cap cooling water control system according to claim 5, wherein an adjustable counterpressure to the water pressure of the cooling water in the conduit portion can be applied on the movable wall.

7. The welding cap cooling water control system according to claim 4, wherein the water receiving device is provided with a pilot control valve.

8. The welding cap cooling water control system according to claim 2, wherein the control unit is formed and programmed such that on the inflow side only the flow control valve is electrically switched in the case of a cap change and/or a leakage in the cooling water conduit, in order to stop the inflow of cooling water to the at least one welding cap.

9. The welding cap cooling water control system according to claim 1, wherein the cooling water conduit extends along several welding caps one after the other, in order to cool the same.

10. The welding cap cooling water control system according to claim 9, wherein only one flow control valve is present.

11. The welding cap cooling water control system according to claim 10, wherein the flow control valve is arranged in the inflow to the first welding cap.

12. The welding cap cooling water control system according to claim 1, wherein several welding caps are cooled via the cooling water conduit and that in total only one single or several flow sensors are present.

13. The welding cap cooling water control system according to claim 1, wherein an associated flow sensor is provided downstream of at least one welding cap.

14. The welding cap cooling water control system according to claim 2, wherein the control unit is formed such that in the case of a pressure drop below a predetermined pressure, which is detected by the at least one flow sensor, the flow control valve is closed.

15. The welding cap cooling water control system according to claim 1, wherein the flow control valve has a flow cross-section which can be amended stepless.
